(19) United States
(12) Patent Application Publication
(10) Pub. No.: US 2008/0317908 A1
(43) Pub. Date: Dec. 25, 2008

(54) FOOD PRODUCTS AND ITS PACKAGING

(75) Inventor: Stephane Hentzel, York (GB)

Correspondence Address: BELL, BOYD & LLOYD LLP, P.O. Box 1135, CHICAGO, IL, 60690, US

(73) Assignee: Nestec S.A., Vevey (CH)

(21) Appl. No.: 12/140,792

(22) Filed: Jun. 17, 2008

Related U.S. Application Data
(63) Continuation of application No. 10/145,294, filed on May 13, 2002, now abandoned.
Application No. 10/145,294 is a continuation of application No. PCT/EP00/09719, filed on Oct. 5, 2000.

(30) Foreign Application Priority Data
Nov. 18, 1999 (EP) 99203869.5

(51) Int. Cl. B65D 85/00; A23P 1/00; A23G 3/50; B65D 85/30; B65D 85/36

(52) U.S. Cl. 426/94; 426/106; 426/126; 426/127; 426/119; 426/103; 426/93

(57) ABSTRACT

The invention relates to a combination of at least one three-dimensional food product and a tray member for displaying the food product thereon. The tray member includes a support base and at least one first retaining member. The food product includes at least a bottom surface arranged so as to rest on the support base and at least one second retaining member. The first and second retaining members are complementarily shaped and arranged to adjust in engagement together so as to be capable to resist disengagement at least in a direction substantially parallel to the support base.

### CROSS-REFERENCE TO RELATED APPLICATIONS

This application is a continuation of the US national stage designation of International application PCT/EP00/09719 filed Oct. 5, 2000, the content of which is expressly incorporated herein by reference thereto.

### TECHNICAL FIELD

The present invention relates to a food product and a package that is adapted specially to receive the food product while providing an attractive display of the food product. The present invention relates more particularly to food items of relatively small size that are sensitive to the pressure and/or puncture such as chocolate and confectionery products.

### BACKGROUND ART

In the food industry, it is desirable to provide food products in a package wherein the food products are properly secured during transit and which also provide an attractive appearance for the consumer.

Food products such as chocolate and the like are often presented in an assortment box which comprises a thermoformed tray or vacuum-formed-tray (VFT) where each piece of chocolate is individually located in an individual cavity that is complementary shaped and provided within the tray. More particularly, the tray is formed of a plastic sheet that is deformed by vacuum so as to provide a multi-cavity member as shown in prior art FIGS. 1 and 2. Generally, the tray is not self-supportive and needs to be placed within a cardboard box. A transparent or opaque lid also covers the box in order to protect the chocolates from the external environment. Some additional cushioning may also be required.

Due to the relatively uneven shape of these conventional vacuum-formed-trays, the decoration of the tray is difficult to achieve without risking distortion of the decoration pattern. Moreover, a flat decoration positioned underneath the tray is also not very visible from above the tray and is consequently not a satisfactory solution.

A conventional tray has also to adapt specifically to the profile of the food products that are received therein by matching the shape of the cavities to the external profile of the food products. Therefore, the tray has to be specifically designed to a given series of food products but may not be suitable for another series having different profiles. Consequently, the development costs for the packaging increase proportionally to the number of new assortment lines developed.

Therefore, there exists a need to provide an innovative way of displaying food products in order to show off the features of the food products while still properly securing them for transport and manipulation. There is also a need for a more flexible and economical way of displaying the food products that would be independent of the outer shape or profile of such products.

Other drawbacks of conventional VFT packages are related to the difficulties the consumer may have to take hold of the food product when it rests within its cavity. Generally, the consumer takes the product by gripping the two diametrically opposed sides of the food product that protrude out of the recess. However, the sides may have a relatively small length to provide a good grip that can lead in some cases to inconvenient situations. If the recess is made too shallow for allowing a better grip of the food product, then there is a risk that the food product will leave its cavity during transport or manipulations of the packaging. In case the lid is made transparent, the content of the box does no longer look attractive and re-arrangement in the box of the food product is needed before a sale can be made.

EP 2295309 relates to improvements in packaging for food products, especially cakes, in which a support for a food product is provided having one retaining element extending therefrom, the retaining element being so shaped as to be able to penetrate the food product when the food product contacts the support during packing. The support prevents the food product from sliding when the food product is removed from its outer packaging. However, there is no visible improvement of the display of the food product. There is also no benefit in term of ease of gripping of the food product. Furthermore, the penetration of the retaining means may affect the integrity of the food product, especially for food products of small size that are usually sensitive to the pressure and/or the puncture such as confectionery or chocolate products, and especially filled products.

The present invention now provides a new tray construction that resolves the problems of the art.

### SUMMARY OF THE INVENTION

The present invention relates to the combination of at least one three-dimensional food product and a tray member for displaying said food product thereon. The tray member comprises a support base and at least one first retaining means. The food product comprises a side portion, a bottom surface arranged so as to rest on the support base, and at least one second retaining means. The second retaining means is preferably built-in to the bottom surface. The first and second retaining means are arranged to adjust in shape engagement together so as to be capable of resisting disengagement at least in a direction substantially parallel to the support base.

Such a solution of packaging is less fussy while the food product remains properly secured on the tray member. The food product can be packed in a more economic manner and in a more visible and attractive manner. Due to the built-in construction of the retaining means to the food product, the food product can be placed in position on the tray member without pressure nor perforation, therefore causing no risk of damage to the food product. The method of displaying and securing the food products can also be made independently from the outer profile of the food products to thus provide much more flexibility in the way of developing various and new lines of food products. The invention also facilitates the lifting of the food product by the consumer for consumption.

In a preferred aspect of the invention, the first and second retaining means are located at an interface between the bottom surface of the food product and the support base of the tray member so that the side portion of the food product is substantially uncovered by the retaining means.

Therefore, compared to a conventional packaging, the food in a package according to the invention is shown off to its advantage as it is visible in three dimensions. Also, access to the food product is rendered easier. In particular, the ease for lifting the food product from the tray is improved as the consumer can grasp the food product along essentially its entire side portion.

More particularly, the first and second retaining means are preferably of a size smaller than the contour of the food product so that they remain invisible when engaged. Therefore, in addition to the previously mentioned advantages, the package creates the visual impression that the food products are placed separately on the tray member with relatively empty spaces therebetween, and this also facilitates gripping of the food products.

In another aspect of the invention, the first and second retaining means form together an arrangement comprising a projection engaging a complementary-shaped cavity. Therefore, the food product is particularly shaped to fit the package. The food product can be disengaged easily by lifting upwardly the food product and without risking damage to the food product as a better grip is gained on the side portion of the food product. At this point, the food product is typically less sensitive to pressure from the consumer's fingers compared to the upper portion or upper edges of the food product. In normal storage and transport conditions, the food product is properly secured at a degree at least equivalent to conventional packages.

The invention aims more particularly at displaying a plurality of food products on a same tray member. For that, it is advantageous to have a plurality of first retaining means provided on a support base that is capable of receiving and displaying a series of food products thereon, with each food product comprising at least one second retaining means and at least one of each being adapted to complementary fit with at least one of the first retaining means. Preferably, the first retaining means are spaced apart one from another by a distance sufficient to clear the side portions of all the food products of the series when in position on the support base. Therefore, the lifting of each individual food product is made possible without disarranging the other food products on the tray member.

In another interesting aspect of the present invention, the support base forms a substantially regular surface with no significant variation of height outside of the contour of at least the first retaining means of the tray member. By this arrangement, the visibility of the tray decoration is improved. The decoration under the tray member is also rendered easier to carry out with less or even no problems of distortions of the decorative pattern. The packaging can also be made relatively simpler and cheaper. Surprisingly, thinner materials for the tray member can be used while still providing a satisfactory holding of the food product. The weight of the package is also consequently reduced constituting thus a potential source of cost savings. By “no significant variation of surfaces”, it is meant that the variations of thickness are kept to a minimal extent. However, very slight abrupt or progressive variations of 1-2 mm or less for decorative purposes or centring of the food product in proper location, are considered as included in the scope of the present invention.

### BRIEF DESCRIPTION OF THE DRAWINGS

The invention will now be described, purely by way of non-limited examples, with reference to the appended drawings, in which:

FIG. 1 illustrates a perspective view of a state-of-the-art packaging arrangement for a series of individual food products in what is commonly called an assortment box;

FIG. 2 is a diagrammatic cross section view of a FIG. 1 taken along line A-A;

FIG. 3 illustrates a perspective view of a combination of food products and package according to the present invention;

FIG. 4 is a section view taken along B-P of FIG. 3;

FIG. 5 is an enlarged view of the food product and part of its packaging support;

FIG. 6 illustrates a partial top view of a possible embodiment of the present invention;

FIG. 7 illustrates a view similar to FIG. 6 according to another variant;

FIG. 8 is a section view taken along C-C of FIG. 7,

FIG. 9 is a diagrammatic side view of an embodiment of the invention;

FIG. 10 is a cross-section view of another variant of the invention;

FIG. 11 shows a series of possible shapes for the retaining means of the invention;

FIG. 12 is a cross section of an embodiment in which the food product comprises a hole extending all the way through the food product;

FIG. 13 shows a possibility for arranging of the food products on the tray member;

FIG. 14 illustrates another variant of the invention;

FIG. 15 illustrates a variant in which the retaining means of the tray member are discrete elements connected to a supportive plate member;

FIG. 16 illustrates a variant in which the retaining means of the tray member are cut in a rigid plate and bent so as to form outwardly protruding means;

FIG. 17 illustrates a final packaging unit covered by a lid; and

FIG. 18 illustrates a possible method for manufacturing a food product of the invention.

### DETAILED DESCRIPTION OF THE PREFERRED EMBODIMENTS

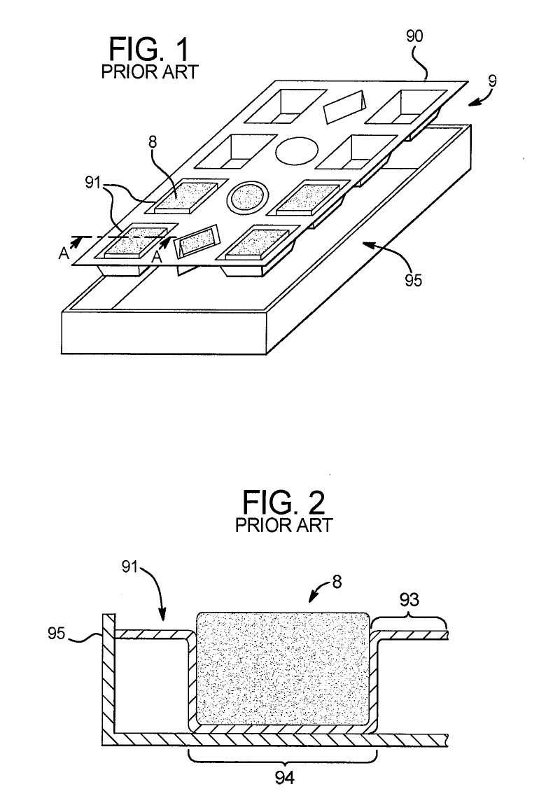

FIGS. 1 and 2 are provided to illustrate a known combination of food products 8, such as chocolates or other confectioneries, and a packaging unit 9. The packaging unit comprises a vacuum-formed tray 90 having a plurality of open cells 91 forming complementary recesses for receiving individual chocolates. The tray is formed of a thermoformed sheet with upper raised portions 93 and lower recessed portions 94. The succession of raised and recessed portions makes the tray complicated and tortuous. It gives almost no simple possibility of decoration of the tray. A lower cardboard box 95 is provided to receive and support the tray. An upper lid can be added to protect the products and further to support the tray. A cushioning material or layer can be further added, and is preferably placed between the tray and the lid.

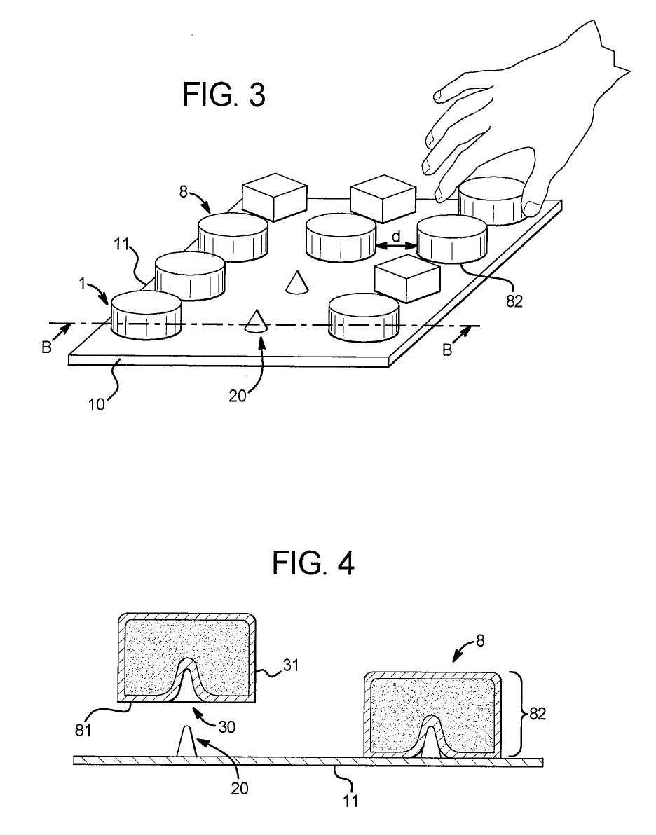

FIGS. 3 and 4 illustrate the novel combination of the invention. The food products are identified by reference numeral 8, purely by way of non-limitative example, as a confectionery product, but other items, such as a chocolate, a sugar confection, a biscuit or any similar edible solid material can be used.

The combination comprises a package unit 1 and at least one food product, and preferably a series of food products 8. According to a characteristic which will be described in greater detail later, the package unit comprises a tray member 10 that includes retaining means 20 which cooperate with complementary shaped retaining means 30 of the food product. The tray member comprises a support base or bearing portion 11 which is preferably a substantially evenly flat or rectilinear surface forming a base of support on which the food products can rest. The retaining means 20 of the tray member protrude upwardly from the upper surface of the support base 11. The retaining means have a general shape of upwardly projecting protrusions, with one for each individual food product. The protrusion may have the shape of a spike, a cone or even a more rounded shape, as desired.

Each food product has complementary retaining means in the form of a cavity 31 provided at the bottom surface 81 of the product.

The retaining means 20, 30 are small enough to be completely encompassed within the outside contour of the food product while leaving the sides of the food product substantially uncovered. As to the implication of the size and location of the retaining means, the lateral portions or side walls 82 of the food product extend sufficiently upwardly from the support base 11 to constitute free zones of gripping of the food product. As opposed to the known combination of the art, the side wall of the food product is uncovered or substantially uncovered by the package in order to obtain a visual 3-D aspect that the food products are placed separately on a flat surface with no visible attachment means.

Importantly, when a series of food products is disposed on a tray member such as shown on FIG. 3, the retaining means or projections 20 need to be spaced apart by a certain distance one from the other depending upon the overall projected surface of each food product so as to leave sufficient room in-between. The distance “d” between each adjacent food product has to be sufficient to allow the fingers to be inserted for grasping and lifting of an individual food product without interfering with or disarranging the other food products on the tray member. For instance, the distance between each food product can be set at a length of at least 1 cm, and preferably between 1.5 and 3 cm. In an alternative, also due to the absence of raised portions extending upwardly between the food items, it may also be envisioned that the free distance between each product be reduced to a minimum so as to increase the number and coverage of food products by unit area on the tray.

With reference to FIG. 5, it is intended that the retaining means have substantially complementary shapes. By this is meant that the retaining means are capable of fitting closely so as to prevent excessive movement of the food product with respect to the tray member. It is further intended that the movement substantially parallel to the tray member be secured so as to keep a proper organized arrangement of the food products. However, a rotational movement of the food product around the vertical axis of each projection can be envisioned. On the other hand, the food product should be lifted upwardly without risking a breakage of part of the food product.

It is so preferred that the food product has a premolded tapered cavity with its larger base 34 being located at the lower surface 81 of the food product and extends with a narrower upper end portion 35. For instance, the cavity may form two distinct adjacent portions; a base portion 34 having a first angular inclination θ₁ with respect to the bottom surface and a end portion 35 having a second angular inclination θ₂ greater than the angular inclination θ₁. Thus, the first base portion will favor a ramp effect to guide in a correct positioning of the food product onto its intended respective projection 20. It will allow a positioning tolerance during the loading of the tray member and will efficiently reduce the time for loading of the tray member either manually or mechanically. The restricted section of the upper end portion 35 will promote the securing of the food product with very limited or no possibility of transversal movement.

The shape of the projection extending from the support base may either be exactly fitting with the cavity; i.e., with a larger base projecting portion 24 and a restricted end projecting portion 25. In an alternative, the projections may constitute a simple progressively tapered spike-shape as previously illustrated in FIGS. 3 and 4.

FIG. 5 also shows that the food product of the invention may include a shell-like layer 83 such as in a filled chocolate and the like. More particularly, the shell 81 surrounds an interior filling 84 such as a syrup, flavored for example with coffee or fruit flavors, a cream, a piece of nut a or nougat or any other types of fillings. Therefore, the shell 83 defines a properly closed volume for the filling. In order to prevent problems of leakage of the filling, it should be pointed out that the shell forms the second retaining means; i.e., the cavity 30. The shell has to be sufficiently rigid and thick not to be easily punctured or broken during the loading or unloading of the tray member. Preferably, the shell will be made by molding of chocolate or a like product, or of a dough product. The thickness of the shell may be variable depending upon the nature or strength of the material required. For instance, the thickness in the region of the cavity can be increased with respect to the thickness of the rest of the shell, or in an alternative, an additional reinforcing material such as a properly shaped wafer or the like can be positioned to reduce the risk of accidental breakage and/or leakage.

As shown in FIGS. 3 and 5, the tray member can advantageously be decorated beneath the support base. One of the advantages of the invention comes from the fact that the support base of the tray member is relatively flat so that, when made of a transparent material, any decoration on the lower side of the base will appear clearly therethrough with no or very reduced problems of image distortion as opposed to the known thermoformed tray of the state-of-the-art. Preferably, the support base includes a support layer 110 made of a transparent or translucent substantially rigid material and a decorative layer 111 such as a paper or the like located underneath. The decorative layer may, for instance, be printed with decorative ink patterns 112. It can also be envisioned that the support layer 112 will be the only layer of the tray and that the decoration be printed directly upon the support layer either onto the external or internal side. Decoration by heat transfer or mechanical pressure transfer can also be used. Decoration on a plurality of superposed layers to provide special effects can also be made in order to improve the attractiveness of the packaging. It can be noted that an image provided on the tray member will appear more visible as the food products are progressively taken for consumption. This opens the possibility of creation for numerous combinations of games and contests, for instance. The image can be a photo, picture or other abstract graphic, which can be printed, embossed or imparted by some other means onto a wide range of packaging materials such as paper, plastic, wood, etc. In an alternative, a food-acceptable decorative layer may also be positioned at the top surface of the support layer 110.

In general, the tray member can be made of various traditional packaging materials. However, it is preferred that the tray member includes at least one layer of plastic or metal. More precisely, the tray member comprises a plastic or metallic material having a thickness sufficient to confer a proper holding for the food product. More preferably, the retaining means 20 are formed integrally with the plastic or metallic layer that is deformed accordingly. In the case of plastic, the plastic layer is thermoformed to form the retaining means. Thermoforming is preferably vacuum forming or pressure assisted vacuum forming. As the height of the projections may be relatively low, the thickness of plastic for the overall tray can be reduced to 20% by weight or less compared to a conventional vacuum-formed tray. The thickness of thermoformed plastic to form sufficiently rigid projections can be of 80 microns or less. A suitable thermoplastic material is PVC. Other materials such as expanded polystyrene or polypropylene, tin plate, pressed paperboard, aluminium, or molded fibers can also be used.

Depending upon the nature of the material, the retaining means will be formed according to different other techniques such as injection, blow molding, stamping or cutting/bending.

In another possibility the tray member can be made of edible products such as a wafer or another dough product or even a chocolate layer or a sugar sheet.

FIG. 6 illustrates a first variant in which a series of retaining means are provided on separate bands 26 attached to the base portion 11 of the tray member. The bands are fixed by any suitable connection means such as gluing or welding or mechanical connections. Each band may be, for instance, a thermoformed band with integrally formed projections 20 therein. The construction of separate bands offers the possibility of choosing a material for the rest of the tray which is different from the material of the bands; e.g., less expensive or with specific or different mechanical properties or different thicknesses. For instance, the bands can be of thermoformable plastic whereas the rest of the tray is in cardboard or a non-thermoformable plastic. The bands may be arranged in parallel rows which are spaced apart a certain distance sufficient to allow an easy gripping of each individual food product. The bands could also be differently positioned such as to form a crossed arrangement.

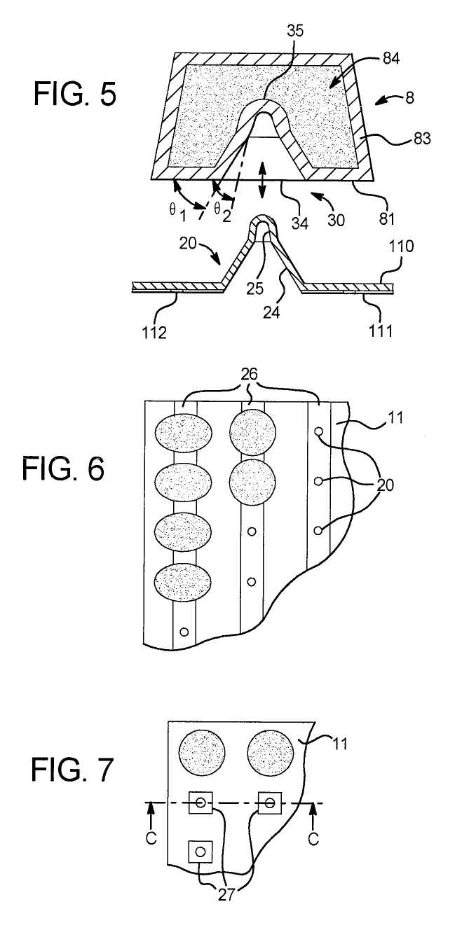

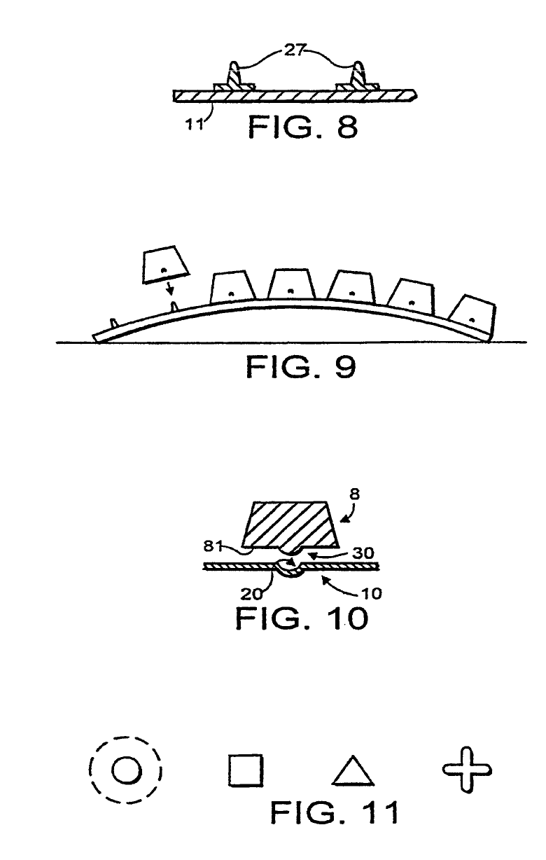

FIGS. 7 and 8 show another variant in which the projections are individually provided in discrete pieces 27 which are attached to the at least one support layer of the support base of the tray member. The individual pieces present the advantage that they can be placed in any locations according to a predetermined desired pattern. This presents a very flexible way of displaying the food product on the package. The individual pieces may preferably be adhesively attached to the rest of the tray member.

The tray member can encompass various general profiles such as the one illustrated by FIG. 9. For instance, the tray member can be curvilinear; i.e., comprising convex and/or concave portions, while still keeping its general advantageous characteristics.

It is meant that the retaining means in the context of a convex and/or concave general shape still confer a resistance to disengagement in the direction substantially parallel to the support base; i.e., more precisely in a tangent direction to the base portion. It is clear that in the present context, parallel also means tangent to the curvilinear base portion as opposed to a normal direction to the tangent direction.

FIG. 10 illustrates another possibility in which the male retaining means or protrusion 30 projects from the bottom surface 81 of the food product whereas the female retaining means 20 is provided onto the surface of the tray member. As previously mentioned, the female retaining means can be a cavity formed within the support base of the tray member, for instance, by thermoforming such as vacuum forming.

With regard to the shapes of the retaining means, it must be noted that there is no particular shape and dimensional restrictions provided they are able to confer a correct positioning and the desired limitation of movement. FIG. 11 shows various possible shapes. The retaining means may encompass cross-sections in the form of circle, polygon such as square or triangle, or complex shapes such as a cross and the like. Angled shapes will properly secure the movement of the food products in rotational direction.

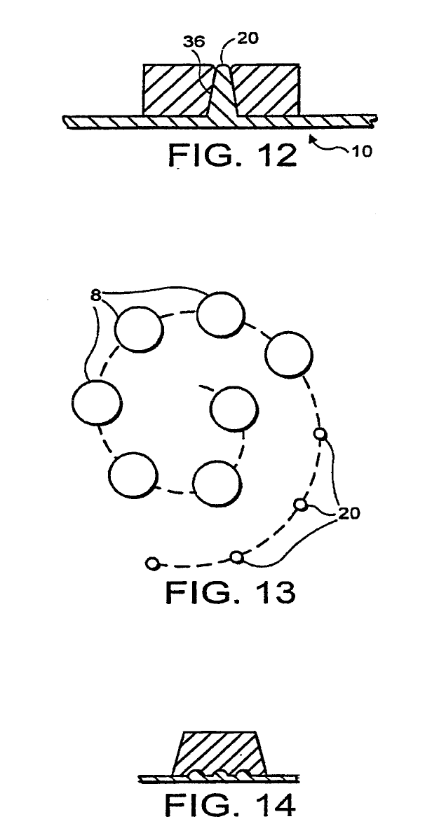

Of course, the principle of the invention remaining unchanged, details and embodiments may be varied widely from those described and illustrated without departing from the scope of the present invention. This applies to various aspects of the arrangement illustrated by way of examples in the appended drawings such as in FIG. 12, which shows a food product having a traversing hole 36 that extends vertically throughout the whole width of the food product. The hole 36 serves as female retaining means for a complementary shaped protrusion 20 protruding from the surface of the tray member 10.

FIG. 13 illustrates an example for disposing the retaining means on the surface of the tray member so as to form an original geometrical pattern such as an alignment of the food products in a spiral. Therefore, the novel method for holding the food products gives a great flexibility to create original presentations.

The connection between the food product and the tray member could also be obtained by multiple retaining means or complementary corrugated surfaces at the interface of the food product and the support base of the tray as represented in FIG. 14.

In another example, FIG. 15 shows a layer 113 of the support base with a plurality of apertures 28 provided therethrough. Discrete pin members 29 engage the apertures 28 from underneath. The pin member comprises a larger base that comes into abutment against the lower surface of the layer 113. The securing of the pins members is made either by gluing of the pins members directly to layer 113 or by laminating a further layer 114 under the surface of the upper layer 113 to form the support base 11. Lamination of layers 113, 114 may be produced by gluing, welding, riveting or any suitable connection means.

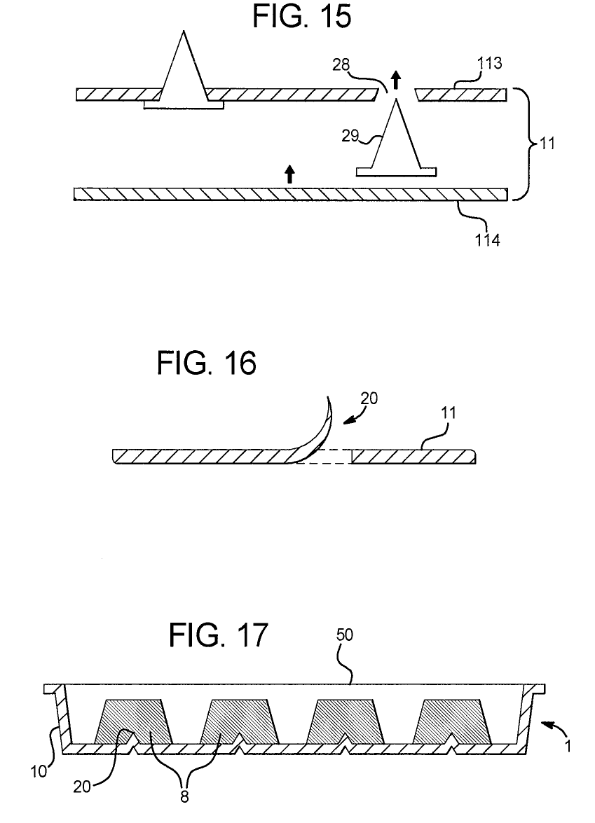

In FIG. 16, the retaining means 20 are produced in a plate that is made of relatively rigid and permanently deformable material such as a tin or aluminium plate. The contour of each retaining means is stamped into the plate, for example, by a hydraulic press or any suitable mechanical stamping means. Then, the stamped part is raised by bending to form an upwardly substantially hook-shaped protruding portion of the plate.

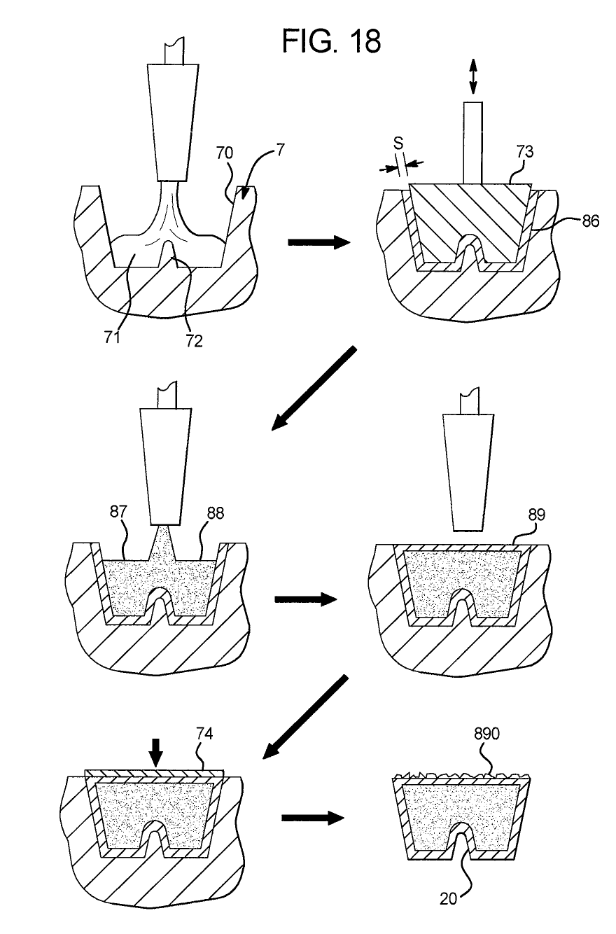

FIG. 17 shows a complete packaging unit comprising a tray member 10 in the form of a tub with raising sides demarcating an inner volume that extend laterally by upper side edges. The tub is closed by a lid 50 which can be a flexible web securely attached to the upper side edges. The web can be a transparent plastic film heat sealed to the edges of the tub. The tub may be preferably a rigid metal, plastic or cardboard piece with stamped or molded protrusions 20. As it is apparent from the figure, the packaging unit may be limited at a minimum of two elements; i.e., the tub and the sealed lid and optionally a cushion pad therebetween. If one compares the invention with the conventional VFT package of FIGS. 1 and 2, the reduction of packing elements to only two or three items consequently results in a more visible, attractive and cost effective food/package combination.

Different ways of forming the shaped food product with its retaining means into the base of the food product may be successfully used, as desired.

FIG. 18 illustrates a preferred method of forming the food product, in particular, chocolates filled with various filling such as fondant, liquor or syrups, etc., so as to make assortment sweets.

The method comprises:
(a) providing a mold 7 having a cavity 70 of the size of the food product to be obtained and having a bottom portion 71 in which is formed a protrusion portion 72;
(b) filling at least partly the mold 7 with a liquid solidifiable edible material;
(c) forming a cup-shaped shell 86 of solidified edible material in which the protrusion portion 72 is covered with a layer of the edible material while forming an open cavity 87 within the shell;
(d) filling a center portion 88 of a second edible material within the open cavity;
(e) applying a bottom portion or lid portion 89 of edible material to close the filled cavity;
(f) demolding the molded food product so as to obtain a food product having a bottom portion with a recess portion 20 within the shell at the place of the protrusion portion of the mold.

The operation of forming the cup-shaped shell may comprise the application in the mold of a cooling male die 73 having substantially the same shape as the cavity of the mold but proportionally smaller with a recess portion in its lower surface so as to provide a continuous space “s” between the surface of the mold and the surface of the die including the region of the protrusion portion of the mold.

The operation of filling the edible materials for the shell and filling can be carried out by well known methods such as depositing or injection.

In an alternative, the method includes filling the mold with an excess of the edible solidifiable material, then, turning over the mold to remove the excess of edible solidifiable material and, optionally applying vibration and/or shaking, while leaving a thickness of solidified edible material along the wall of the mold including the region of the protrusion portion.

It must be pointed out that the molded food product of the A invention would be considered “upside-down” at display since the upper surface of the food product as molded in the mold will form the uppermost surface visible from the consumer while the lower molded surface with its molded recess will constitute the lowermost hidden portion of the food product at rest on the tray. Traditionally, a molded food product such as a conventional chocolate product obtained in a flat mold as aforementioned would have to be reversed to show off its lower molded surface which is more attractive due to a better surface finish or quality. The upper surface of the chocolate in the mold would constitute the bottom surface of the chocolate at display.

In order to produce a visually acceptable molded food product, the present invention proposes to improve the uppermost surface of the food product when resting in the mold by applying a surface treatment or decoration 890 onto the upper surface 89 of the food product. One approach consists in placing a decorative sheet or transfer 74 onto the surface. The sheet may comprise an embossed pattern to form an imprint on the surface. It may also be a smooth surface to form a glazed finish. It may also be a decorative transfer such as a decal or a “cocoa butter transfer”. A “cocoa butter transfer” is a sheet of paper onto which is applied a pattern made of cocoa butter containing pigments. In all cases, the sheet or transfer is placed onto the food product after backing off, while the food product of the lid portion is still substantially liquid, and leaving the sheet or transfer in place until cooling is complete. In this way, the final food product will carry the desired pattern on its upper surface to confer a more attractive appearance.

Preferably, the edible material for the shell is a solidifiable fat-based material such a chocolate-based material or pure chocolate. The filling can be of various edible materials such as liquors, syrups, paste, fondant, fudge, caramels, powder, granular, etc.

The method of the invention permits to manufacture food products such as assortment chocolates, fondants or other types of filled confections.

A simplified method can also be carried out for making solid molding food products such as solid chocolates. The method would consist in filling with the liquid solidifiable food product in a mold having similar characteristics as the one of FIG. 18 until the mold is full and, optionally applying a specific treatment of the upper surface of the food product before the surface solidifies.

Other known methods of molding may be used to produce the food product with a proper finish for all the surfaces of the sweet including its upper surface such as with “book molding” or “one shot depositing”.

What is claimed is:

1. A combination of at least one three-dimensional food product and a tray member for displaying the food product thereon, wherein:
the tray member comprises a support base and at least one first retaining means for retaining the food product therein;
the food product comprises a side portion, a bottom surface arranged to rest on the support base and at least one second retaining means that forms part of the bottom surface, with the second retaining means being configured to adjust in shape engagement with the first retaining means of the tray member to resist disengagement of the food product from the tray member at least in a direction that is substantially parallel to the support base.

2. The combination of claim 1, wherein the first and second retaining means are respectively located at an interface between the bottom surface of the food product and the support base of the tray member so that cover the side portion of the food product is not covered.

3. The combination of claim 2, wherein the first and second retaining means are of a size that is smaller than that of the food product so that they remain invisible when the retaining means are engaged.

4. The combination of claim 1, wherein the first and second retaining means form together an arrangement wherein one is a projection and the other is a complementary-shaped cavity which engages the projection.

5. The combination of claim 4, wherein the second retaining means is the projection and the first retaining means is the complementary-shaped cavity.

6. The combination of claim 1, wherein the support base includes a substantially flat surface with no significant variation outside of the first retaining means.

7. The combination of claim 6, wherein the base portion has a substantially rectilinear profile.

8. The combination of claim 6, wherein the support base has either a convex or concave profile.

9. The combination of claim 4, wherein the cavity has a tapered shape with a larger base and a narrower end portion.

10. The combination of claim 9, wherein the cavity has a base portion having a first angular inclination with respect to the bottom surface and an end portion having a second angular inclination that is greater than the first angular inclination.

11. The combination of claim 1, wherein the tray member is made of at least one layer of a formable material and the second retaining means is formed by permanent deformation in at least one layer of the tray member.

12. The combination of claim 11, wherein the at least one layer of the tray member is made of plastic or metallic material.

13. The combination of claim 12, wherein the at least one layer of the tray member is made of a transparent or translucent material and further comprising a decorative layer beneath the tray member layer.

14. The combination of claim 1, wherein a plurality of first retaining means are provided on the support base for receiving and displaying a series of food products thereon, with each food product comprising at least one second retaining means that is adapted to complementary fit with at least one first retaining means; wherein the first retaining means are spaced apart one from another by a distance sufficient to clear the side portions of the food products of the series when positioned on the support base to enable lifting of each individual food product without disarranging the other food products.

15. The combination of claim 1, wherein the tray member is made of at least one layer of a formable material and a series of first retaining means are provided on bands or discrete pieces that are attached to the at least one support layer of the tray member.

16. The combination of claim 1, wherein the first and second retaining means have respective cross-section in the form of a circle, a polygon, or a complex shape.

17. The combination of claim 1, wherein the food product is a confection, a chocolate or a biscuit.

18. The combination of claim 17, wherein the food product has a shell and a filling, with part of the shell forming the second retaining means.

19. The combination of claim 18, wherein the shell comprises a cup-shaped portion and lid portion attached thereto to define an internal closed volume for the filling, with the bottom surface being formed by part of the shell which defines the retaining means therein.

20. The combination of claim 17, wherein the shell and second retaining means are formed in a mold that includes a counterform of the first retaining retaining means therein.
